(19) United States
(12) Patent Application Publication
(10) Pub. No.: US 2026/0142286 A1
(43) Pub. Date: May 21, 2026

(54) SEALING PLATE FOR FLAT BATTERIES, AND FLAT BATTERY

(71) Applicant: Panasonic Intellectual Property Management Co., Ltd., Osaka (JP)

(72) Inventor: MASAO OOTSUKA, Osaka (JP)

(21) Appl. No.: 19/128,193

(22) PCT Filed: Jul. 31, 2023
(86) PCT No.: PCT/JP2023/028008

§ 371 Date: May 8, 2025

(30) Foreign Application Priority Data
Nov. 18, 2022 (JP) 2022-184941

(51) Int. Cl. H01M 50/153; H01M 10/04; H01M 50/109; H01M 50/159; H01M 50/167; H01M 50/184; H01M 50/198

(52) U.S. Cl. CPC H01M 50/153; H01M 10/0427; H01M 50/109; H01M 50/159; H01M 50/167; H01M 50/184; H01M 50/198

(57) ABSTRACT

A sealing plate for a flat battery includes a formed body of a metal plate. The formed body includes a disk, a side wall having a cylindrical shape extending from a peripheral edge of the disk, and a fold. The side wall includes a step. In the fold, the metal plate is folded back to an inside of the cylindrical shape of the side wall at an end of the side wall.

### TECHNICAL FIELD

The present disclosure relates to a sealing plate for a flat battery, and a flat battery.

### BACKGROUND ART

A flat battery is used as power sources for various electronic devices and the like. Various proposals have been made on an exterior body of a flat battery.

FIG. 1 of PTL 1 (Unexamined Japanese Patent Publication No. 2012-190758) discloses a flat battery including a sealing can in which the cylindrical portion thereof has an unfolded opening end.

Claim 1 of PTL 2 (Unexamined Japanese Patent Publication No. H9-283102) describes “a coin battery including a sealing plate having a U-shaped fold at a peripheral edge, a bottomed cylindrical positive electrode case, and an insulating gasket interposed between the positive electrode case and the sealing plate, the coin battery being a lithium battery sealing a power generating element with an inwardly crimped positive electrode case opening, in which, when a compression ratio of the insulating gasket between a tip of the U-shaped fold of the sealing plate and the positive electrode case is maintained in 40% to 60%, a compression ratio of the insulating gasket between a distal end of the positive electrode case and the sealing plate is maintained in 60% to 80%, and a compression ratio of the insulating gasket between a distal end of the sealing plate and the positive electrode case is maintained in 50% to 70%”. In addition, FIG. 1 of PTL 2 discloses a sealing plate having an outwardly folded peripheral edge.

### CITATION LIST

### Patent Literature

PTL 1: Unexamined Japanese Patent Publication No. 2012-190758
PTL 2: Unexamined Japanese Patent Publication No. H9-283102

### SUMMARY OF THE INVENTION

One aspect of the present disclosure relates to a sealing plate for a flat battery. The sealing plate includes a formed body of a metal plate. The formed body includes a disk, a side wall having a cylindrical shape extending from a first end connected to a peripheral edge of the disk to a second end, and a fold folded back from a base connected to the second end of the side wall and extending to a tip. The side wall includes a step. In the fold, the metal plate is folded back to an inside of the cylindrical shape of the side wall at the second end of the side wall.

A flat battery according to another aspect of the present disclosure includes an exterior body, and a positive electrode and a negative electrode disposed inside the exterior body. The exterior body includes a case, a sealing plate, and a gasket at least a part of which is disposed between the case and the sealing plate. The sealing plate includes a formed body of a metal plate. The formed body includes a disk, a first side wall having a cylindrical shape extending from a first end connected to a peripheral edge of the disk to a second end, and a fold folded back from a base connected to the second end of the side wall and extending to a tip. The first side wall includes a step. In the fold, the metal plate is folded back to an inside of the cylindrical shape of the first side wall at the second end of the first side wall. The case includes a disk-shaped bottom and a second side wall having a cylindrical shape extending from a peripheral edge of the bottom. A part of the second side wall is bent to an inside of the cylindrical shape of the second side wall so as to cover at least a part of the step via the gasket.

The present disclosure provides a sealing plate with which a flat battery that has high sealability between the sealing plate and a case and that causes little liquid leakage can be fabricated. The present disclosure also provides a flat battery using the sealing plate.

### BRIEF DESCRIPTION OF THE DRAWINGS

FIG. 1A is a top view schematically illustrating an example of a sealing plate according to a first exemplary embodiment.

FIG. 1B is a diagram schematically illustrating a cross section taken along line IB-IB of the sealing plate in FIG. 1A.

FIG. 2A is a schematical cross-sectional view of a metal plate in one step of an example of a method for producing the sealing plate according to the first exemplary embodiment.

FIG. 2B is a schematical cross-sectional view of the metal plate in an example of one step after the one step illustrated in FIG. 2A.

FIG. 3A is a top view schematically illustrating an example of a flat battery according to a second exemplary embodiment.

FIG. 3B is a diagram schematically illustrating a cross section taken along line IIIB-IIIB of the flat battery in FIG. 3A.

FIG. 4A is a cross-sectional view schematically illustrating one step of an example of a method for producing the flat battery according to the second exemplary embodiment.

FIG. 4B is a schematical cross-sectional view of the flat battery in an example of one step after the one step illustrated in FIG. 4A.

FIG. 4C is a schematical cross-sectional view of the flat battery in an example of one step after the one step illustrated in FIG. 4B.

FIG. 5 is a cross-sectional view schematically illustrating a structure of an example of a conventional flat battery.

FIG. 6 is a cross-sectional view schematically illustrating a structure of another example of a conventional flat battery.

FIG. 7 is a diagram illustrating a result of calculation of battery capacity of the flat battery according to the second exemplary embodiment.

### DESCRIPTION OF EMBODIMENT

Exemplary embodiments according to the present disclosure will be described hereinafter with reference to examples, but the present disclosure is not limited to the examples that will be described hereinafter. Specific numerical values and materials might be described as examples in the following description, but other numerical values and materials may be employed as long as effects of the present disclosure are produced. In the present specification, a term “numerical value A to numerical value B” includes numerical value A and numerical value B, and can be read as “larger than or equal to numerical value A and smaller than or equal to numerical value B”. When lower limits and upper limits of numerical values relating to a specific physical property, condition, or the like are mentioned in the following description, any of the mentioned lower limits and any of the mentioned upper limits may be freely combined together unless the lower limit is larger than or equal to the upper limit. When examples of configuration elements or examples of a method are listed in the following description, only one of the listed examples may be used, or a plurality of the listed examples may be used in combination unless otherwise specified.

### (Sealing Plate for Flat Battery)

A sealing plate according to a present exemplary embodiment is a sealing plate for a flat battery. The sealing plate will be referred to as “sealing plate (P)” hereinafter. Sealing plate (P) includes a formed body of a metal plate. The formed body includes a disk, a side wall extending from a peripheral edge of the disk, and a fold. The side wall includes a step. In the fold, the metal plate is folded back to an inside of the side wall at an end of the side wall. That is, the fold is formed by folding the metal plate to the inside of the side wall at a position of the end of the side wall.

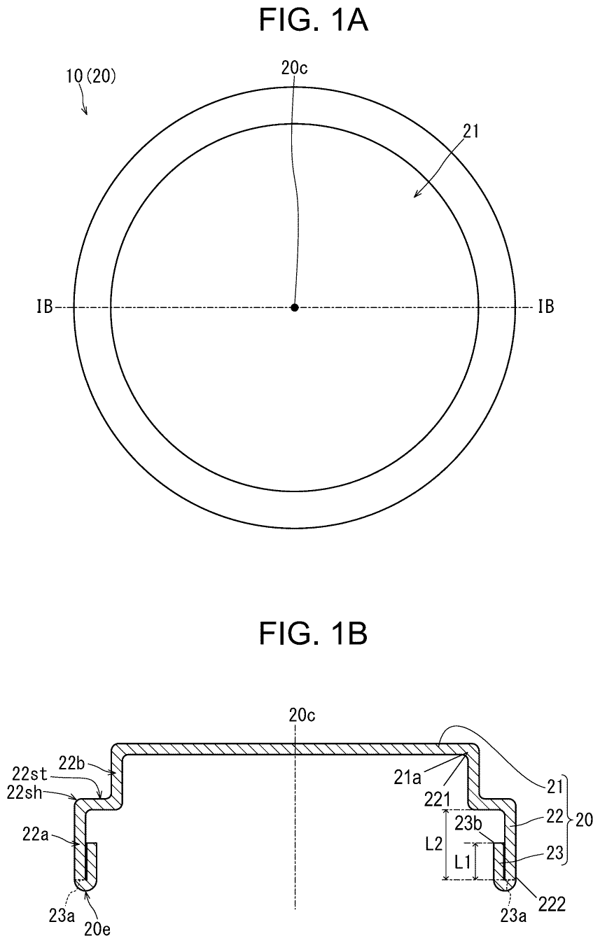

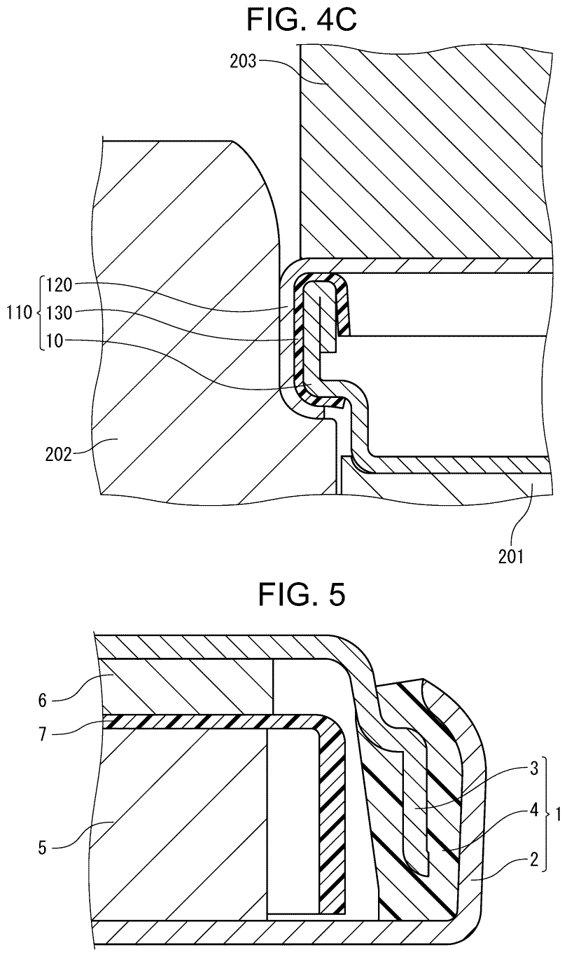

FIG. 5 schematically illustrates a structure similar to that disclosed in FIG. 1 of PTL 1 (Unexamined Japanese Patent Publication No. 2012-190758). Exterior body 1 of a flat battery illustrated in FIG. 5 includes case 2, sealing plate 3, and gasket 4. Positive electrode 5, negative electrode 6, and separator 7 are disposed in exterior body 1. An end of sealing plate 3 in FIG. 5 is not folded back. In this case, the gasket is strongly compressed by case 2 and sealing plate 3 at two locations, that is, a portion near a shoulder of a step of sealing plate 3 and a portion near an opening end of sealing plate 3.

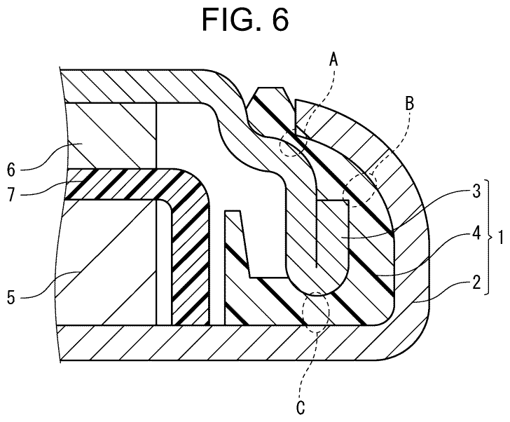

FIG. 6 schematically illustrates a structure similar to that disclosed in FIG. 1 of PTL 2 (Unexamined Japanese Patent Publication No. H9-283102). Exterior body 1 of a flat battery illustrated in FIG. 6 includes case 2, sealing plate 3, and gasket 4. Positive electrode 5, negative electrode 6, and separator 7 are disposed in exterior body 1. An end of sealing plate 3 in FIG. 6 is folded outward. In this case, the gasket is strongly compressed by case 2 and sealing plate 3 at three locations, that is, portion A near a shoulder of a step of sealing plate 3, portion B near a distal end of sealing plate 3, and portion C near an open end of sealing plate 3.

Since volume of a portion where the sealing plate is folded back outward does not contribute to battery capacity in the structure illustrated in FIG. 6, energy density is reduced accordingly. Furthermore, since an edge of the sealing plate abuts on the gasket in the structures illustrated in FIGS. 5 and 6, the gasket is highly likely to be damaged especially when there is a burr at the edge. Furthermore, since strength of a cylindrical portion of sealing plate 3 is low in the structure illustrated in FIG. 5, a compression ratio of the gasket adjacent to the cylindrical portion cannot be increased, and a sealing effect at the portion is weak. In addition, if a compression ratio of the gasket in a cylindrical portion of sealing plate 3 is made too high in the structure illustrated in FIG. 6, the edge of sealing plate 3 is likely to damage the gasket. Therefore, the compression rate of the gasket at the portion cannot be increased, and a sealing effect at the portion is weak.

By using sealing plate (P), on the other hand, a high sealing effect can be produced as described later. By using sealing plate (P), therefore, it is possible to obtain a highly reliable flat battery with less leakage of an electrolytic solution. In particular, by using sealing plate (P), occurrence of liquid leakage can be suppressed even in a high-temperature environment. Furthermore, by using sealing plate (P), it is possible to obtain a high-capacity flat battery with less liquid leakage.

In the step, a diameter of the side wall changes. In the step, the diameter of the side wall is greater in a portion where a length from the disk (i.e., length along the side wall) is greater than in a portion where the length from the disk (i.e., the length along the side wall) is smaller.

The side wall usually includes a cylindrical portion (hereinafter, may be referred to as a first cylindrical portion) between a base of the fold and the step. The side wall may further include a second cylindrical portion existing between the step and the disk. The first cylindrical portion has a greater diameter than the second cylindrical portion. The diameter of the first cylindrical portion may vary gradually from location to location, but is constant or substantially constant. The diameter of the second cylindrical portion may vary from location to location. For example, the second cylindrical portion may have a tapered shape.

Length L1 from the base of the fold to a tip of the fold in a direction parallel to a central axis of the formed body of the metal plate and length L2 from an inner surface of the step to the base of the fold in the direction parallel to the central axis may satisfy 0.2<L1/L2<0.8. When 0.2<L1/L2 is satisfied, the fold can be easily processed. When L1/L2<0.8 is satisfied, a die can be easily disposed at a time of press working, so that the press working becomes easy. L1/L2 may be larger than or equal to 0.3 and smaller than or equal to 0.7.

A material and thickness of the sealing plate are not particularly limited, and may be any material and thickness that can be used for a sealing plate for a flat battery. The sealing plate includes a formed body of a conductive metal plate, and is usually used as a terminal (for example, a negative electrode terminal). Examples of a metal used for the formed body of the metal plate include stainless steel and a nickel-plated steel plate. The thickness of the sealing plate may be greater than or equal to 0.1 mm or greater than or equal to 0.2 mm, and may be smaller than or equal to 0.6 mm, or smaller than or equal to 0.4 mm.

The sealing plate may be formed only of a formed body of a metal plate. The metal plate may include a plating layer formed on the surface thereof as necessary. The plating layer is not particularly limited, and a known plating layer may be used.

When the sealing plate is viewed in a plan view from an opening end (in a reverse direction toward the disk), the fold may be located outside the disk. This configuration makes it possible to use a space in the exterior body particularly effectively, and to increase capacity particularly easily Note that the peripheral edge of the disk (i.e., a boundary between the disk and the side wall) is a portion where the flat plate-shaped disk starts to bend. Note that, when the sealing plate is viewed in a plan view from the opening end, a part of the fold may be located inside the peripheral edge of the disk.

Radius of curvature R of the metal plate (i.e., formed body) at the opening end of the sealing plate may be smaller than or equal to thickness TM of the metal plate, or may be greater than thickness TM. When the metal plate is compressed and crushed at the open end to fold the metal plate, radius of curvature R can be smaller than or equal to thickness TM of the metal plate. By making radius of curvature R greater than thickness TM, it is possible to suppress concentration of force on a part of the gasket at the opening end.

### (Method for Producing Sealing Plate)

A method for producing sealing plate (P) is not particularly limited. Sealing plate (P) may be produced using a known metal processing technique. An example of the method for producing sealing plate (P) will be described later.

### (Flat Battery)

A flat battery according to the present exemplary embodiment includes an exterior body and a positive electrode and a negative electrode disposed inside the exterior body. Hereinafter, the flat battery according to the present exemplary embodiment will be referred to as flat battery (B). The exterior body includes a case, a sealing plate, and a gasket at least a part of which is disposed between the case and the sealing plate. The sealing plate includes a formed body of a metal plate. The formed body includes a disk, a first side wall extending from a peripheral edge of the disk, and a fold. The first side wall includes a step. In the fold, the metal plate is folded back to an inside of the first side wall at an end of the first side wall. The case includes a disk-shaped bottom and a second side wall extending from a peripheral edge of the bottom. A part of the second side wall is folded inward so as to cover at least a part of the step through the gasket.

The sealing plate used in flat battery (B) is sealing plate (P) described above. Overlapping description of matters described for the sealing plate (P), therefore, is omitted. The above-described “first side wall” corresponds to the “side wall” in the description of sealing plate (P). Since flat battery (B) uses sealing plate (P), effects of the sealing plate (P) can be produced.

As described above, the first side wall of sealing plate (P) usually includes a cylindrical portion existing between the base of the fold and the step.

The gasket may include a first portion disposed between an opening end of the formed body and the bottom of the case, a second portion disposed between the cylindrical portion and the second side wall, and a third portion disposed between a shoulder of the step and the second side wall. Ratio T/Tave of thickness T of the second portion at any position to average thickness Tave of the second portion may be in a range of 0.8 to 1.2. That is, the thickness of the second portion may be substantially constant. T/Tave may be larger than or equal to 0.8 or larger than or equal to 0.9, and smaller than or equal to 1.2 or smaller than or equal to 1.1.

When sealing plate (P) is used, a sealing effect in the second portion can be enhanced by compressing the second portion such that the thickness of the second portion becomes substantially constant. Note that thickness T and average thickness Tave are thicknesses in a state of flat battery (B). Thickness T can be obtained by cutting flat battery (B) in the direction along the central axis and measuring thickness of the gasket in a resultant cross section. Average thickness Tave can be obtained by measuring thicknesses T at five points arbitrarily selected in the second portion and arithmetically averaging measured thicknesses T at the five points. In order to make thickness T substantially constant, the thickness of the second portion before the compression (before battery assembly) is preferably substantially constant. For example, ratio T0/T0ave of thickness T0 of the second portion at any position before the compression to average thickness T0ave of the second portion before the compression may be in the range of 0.8 to 1.2. T0ave can be measured in the same manner as Tave.

The thickness of the gasket in the portion compressed between the case and sealing plate (P) may be greater than or equal to 0.05 mm or greater than or equal to 0.1 mm and may be less than or equal to 0.5 mm or less than or equal to 0.25 mm. The thickness of the gasket may vary depending on a location, or may be the same. For example, the thickness of the first portion, the thickness of the second portion, and the thickness of the third portion may be the same as or different from one another. The thickness of the gasket in the compressed portion can be varied depending on the thickness of the gasket before the compression and depending on the compression ratio. The compression ratio can be varied depending on shapes and sizes of configuration elements of the exterior body and depending on a shape of a die used in a crimping step.

The gasket may include a first portion disposed between an opening end of the formed body and the bottom of the case, a second portion disposed between the cylindrical portion and the second side wall, and a third portion disposed between a shoulder of the step and the second side wall. In flat battery (B), following conditions (1) to (3) may be satisfied By satisfying following conditions (1) to (3), leakage of an electrolytic solution can be particularly suppressed. (1) The compression ratio of the gasket in the first portion is in a range of 30% to 70% (e.g., in a range of 40% to 60%). (2) The compression ratio of the gasket in the second portion is in a range of 20% to 50% (e.g., in a range of 30% to 40%). (3) The compression ratio of the gasket in the third portion is in a range of 30% to 70% (e.g., in a range of 40% to 60%).

In flat battery (B), the gasket can be compressed not only in the first portion and the third portion but also in the second portion. That is, in flat battery (B), a high sealing effect can be produced even in the second portion. Leakage of the electrolytic solution, therefore, can be particularly suppressed.

The compression ratio of the gasket can be obtained on the basis of the following equation by measuring thickness TO before being incorporated into the battery and thickness T1 after being incorporated into the battery for a portion where the compression ratio is measured. Compression ratio (%)=100×(thickness T0−thickness T1)/thickness T0

As described above, length L1 and length L2 may satisfy 0.2<L1/L2<0.8.

Flat battery (B) is a flat battery having a circular planar shape. Examples of flat battery (B) include batteries called a button battery and a coin battery. Size of flat battery (B) is not particularly limited. Diameter of flat battery (B) may be in a range of 10 mm to 40 mm. Diameter of sealing plate (P) can be selected from a range slightly smaller than the diameter of flat battery (B) Height of flat battery (B) may be in a range of 1 mm to 8 mm.

A type of flat battery (B) is not particularly limited as long as it is a battery using a sealing plate. Flat battery (B) may be a primary battery or a secondary battery. Examples of the primary battery include a lithium primary battery, an alkaline manganese battery, a silver oxide battery, and other primary batteries. Examples of the secondary battery include a lithium secondary battery, a lithium-ion secondary battery, a nickel-metal hydride secondary battery, and other secondary batteries.

Configuration elements of flat battery (B) are not particularly limited except that sealing plate (P) is used. Known configuration elements used in a flat battery may be used as configuration elements other than sealing plate (P). The configuration elements of flat battery (B) will be exemplified hereinafter. The configuration elements of flat battery (B) are not limited to the following examples.

### (Battery Elements)

Flat battery (B) includes a positive electrode and a negative electrode as battery elements. Flat battery (B) may include a separator disposed between the positive electrode and the negative electrode depending on the type thereof. Flat battery (B) may contain an electrolyte (i.e., an electrolytic solution or a solid electrolyte) depending on the type thereof. Examples of the electrolytic solution include an aqueous solution and a nonaqueous electrolytic solution. Flat battery (B) is particularly preferably used as a battery containing an electrolytic solution, because the sealing effect of the exterior body is high.

The battery elements such as the positive electrode, the negative electrode, the separator, and the electrolyte are selected in accordance with the type of battery. Each of the positive electrode and the negative electrode may have a pellet shape. Alternatively, each of the positive electrode and the negative electrode may include a current collector and a composite layer disposed on the current collector. The composite layer contains an active material.

### (Case)

The case is not particularly limited, and a known case used for a flat battery may be used. As a material of the case, the materials exemplified as the material of sealing plate (P) may be used. Thickness of the case (i.e., thickness of the metal plate constituting the case) may be in the range exemplified as the thickness of sealing plate (P). The case normally functions as a terminal (for example, a positive electrode terminal).

### (Gasket)

The gasket is not particularly limited. As a material of the gasket, a known material of a gasket used for a flat battery may be used. Examples of gasket materials include polyolefins (such as polypropylene), polyphenylene sulfide (PPS), perfluoroalkoxy alkanes (PFA), and polyetheretherketone (PEEK), and other resins.

A shape of the gasket is not particularly limited, but a shape with which the exterior body can be sealed is selected. The gasket preferably includes at least the first to third portions described above.

### (Method for Producing Flat Battery (B))

A method for producing flat battery (B) is not particularly limited. Except that sealing plate (P) is used, a known method for producing a flat battery may be used.

In one example of the production method, first, battery elements are disposed in a space between sealing plate (P) and the case. The battery elements include a positive electrode and a negative electrode, and includes a separator and an electrolyte as necessary Sealing plate (P) and the case are disposed so as to face each other through the gasket. Next, by bending the end of the cylindrical portion of the case inward, sealing plate (P) and the case are sealed with the gasket (i.e., crimping step). Flat battery (B) is thus produced.

Examples of sealing plate (P) and flat battery (B) and an example of a method for producing these will be specifically described hereinafter with reference to the drawings. The examples described hereinafter can be modified on the basis of the above description. In addition, the matters described hereinafter may be applied to the exemplary embodiment described above.

### First Exemplary Embodiment

In a first exemplary embodiment, an example of sealing plate (P) will be described. FIG. 1A is a top view of sealing plate 10 according to the first exemplary embodiment, and FIG. 1B is a cross-sectional view taken along line IB-IB in FIG. 1A. The cross section in FIG. 1B is a cross section including central axis 20c of formed body 20 (i.e., a central axis of first cylindrical portion 22a). Referring to FIG. 1A, sealing plate 10 is formed of formed body 20 of a metal plate, formed body 20 includes disk 21, side wall 22 (hereinafter, referred to as first side wall 22) extending from peripheral edge 21a of disk 21, and fold 23. Side wall 22 includes step 22st. Side wall 22 has end 221 connected to peripheral edge 21a of disk 21 and end 222 on an opposite side of end 221. Side wall 22 has a cylindrical shape surrounding central axis 20c and extending from end 221 to end 222. Fold 23 is formed by folding the metal plate inside the cylindrical shape of side wall 22 at end 222 of side wall 22. Base 23a of fold 23 is indicated in FIG. 1B by dotted lines. Base 23a of fold 23 is connected to end 222 of side wall 22. Fold 23 starts to bend from base 23a. A part of fold 23 farthest from disk 21 of formed body 20 in a direction of central axis 20c constitutes opening end 20e of formed body 20. FIG. 1B illustrates an example in which fold 23 is folded back to such an extent that tip 23b of fold 23 is in contact with side wall 22. That is, in the example of the cross section illustrated in FIG. 1B, fold 23 is folded back such that fold 23 and side wall 22 become substantially parallel to each other. Fold 23, however, may be folded back so as to be inclined with respect to side wall 22. That is, the tip of fold 23 may be separated from side wall 22.

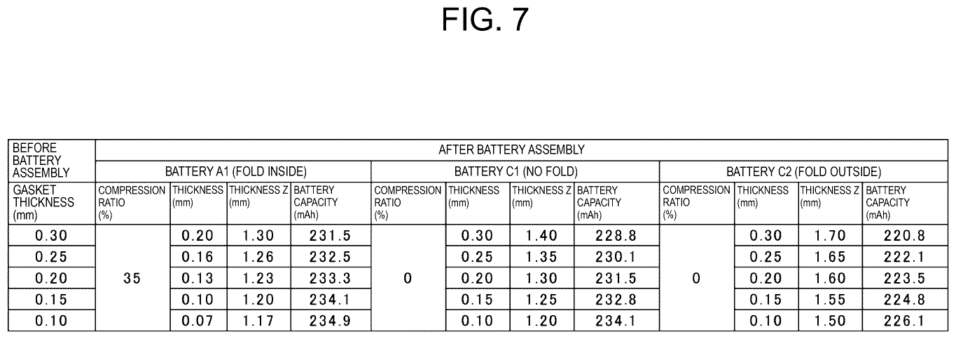

In step 22st, diameter of side wall 22 changes. In step 22st, the diameter of side wall 22 is greater in a portion where a distance from disk 21 (i.e., a distance along side wall 22) is longer than in a portion where the distance from disk 21 (i.e., a distance along side wall 22) is shorter. Note that although FIG. 1B illustrates an example in which step 22st is substantially parallel to disk 21, step 22st may be inclined with respect to disk 21 similarly to sealing plate 3 illustrated in FIG. 7.

FIG. 1B illustrates an example in which side wall 22 includes first cylindrical portion 22a and second cylindrical portion 22b. First cylindrical portion 22a exists between step 22st and base 23a of fold 23. Second cylindrical portion 22b exists between step 22st and disk 21. First cylindrical portion 22a has a substantially constant diameter throughout, but the diameter thereof may vary. Similarly, second cylindrical portion 22b is substantially constant in diameter throughout, but the diameter thereof may vary. For example, second cylindrical portion 22b may have a tapered shape. In the cross section in FIG. 1B including central axis 20c of formed body 20, second cylindrical portion 22b extends substantially perpendicular to disk 21. Step 22st has shoulder 22sh at a boundary with first cylindrical portion 22a.

FIG. 1B illustrates length L1 from base 23a of fold 23 to the tip of fold 23 in the direction parallel to central axis 20c of formed body 20. Furthermore, FIG. 1B illustrates length L2 from an inner surface of step 22st to base 23a of fold 23 in the direction parallel to central axis 20c. L1/L2 is preferably in the above-described range.

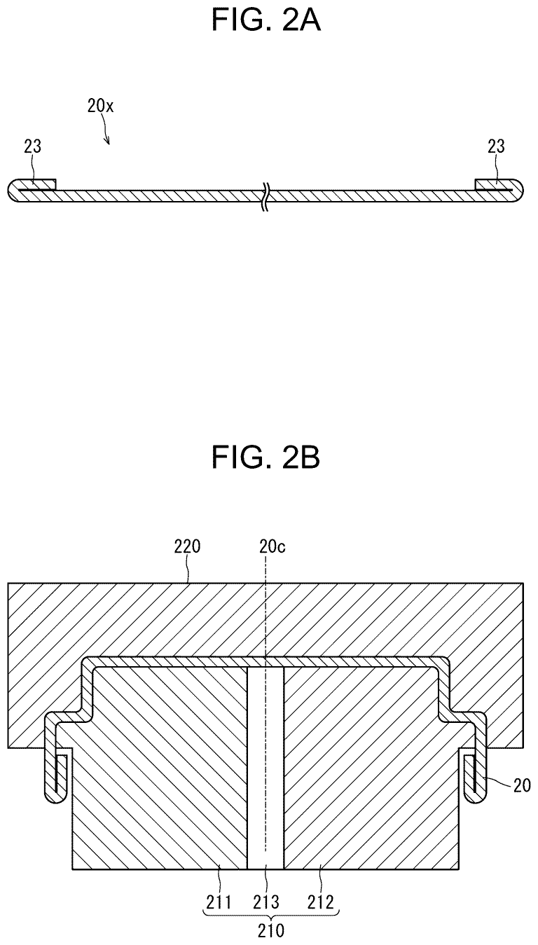

An example of a method for producing sealing plate 10, which includes formed body 20, will be described hereinafter. First, a disk-shaped metal plate is prepared. As illustrated in FIG. 2A, an edge of the metal plate is then folded back inward to obtain metal plate 20x. A folded portion becomes fold 23. A method for performing this process is not limited, and the process may be performed by a known method. For example, the process may be performed by a method called hemming.

Next, metal plate 20x is bent so as to form first cylindrical portion 22a, second cylindrical portion 22b, and step 22st. A bending method is not limited. The bending may be performed by one press working operation or may be performed by a plurality of press working operations.

A cross-sectional view of FIG. 2B schematically illustrates a final state of an example of bending using a split die. FIG. 2B illustrates a state in which metal plate 20x is disposed in lower die 210 and pressed with upper die 220 to deform metal plate 20x into formed body 20.

The exemplary lower die 210 illustrated in FIG. 2B includes three dies 211, 212, and 213. A shape of a press surface of each die is a fan shape having a central angle of 120°. At a time of press working, as illustrated in FIG. 2B, pressing is performed in such a manner that gaps are provided between the dies. Fold 23 is folded back to an inside of formed body 20. In case where formed body 20 is separated from lower die 210 in the state illustrated in FIG. 2B, fold 23 interferes with lower die 210. So, three dies 210 are moved toward central axis 20c of formed body 20, and then, lower die 210 is separated from formed body 20. In this way, formed body 20 (sealing plate 10) can be produced.

### Second Exemplary Embodiment

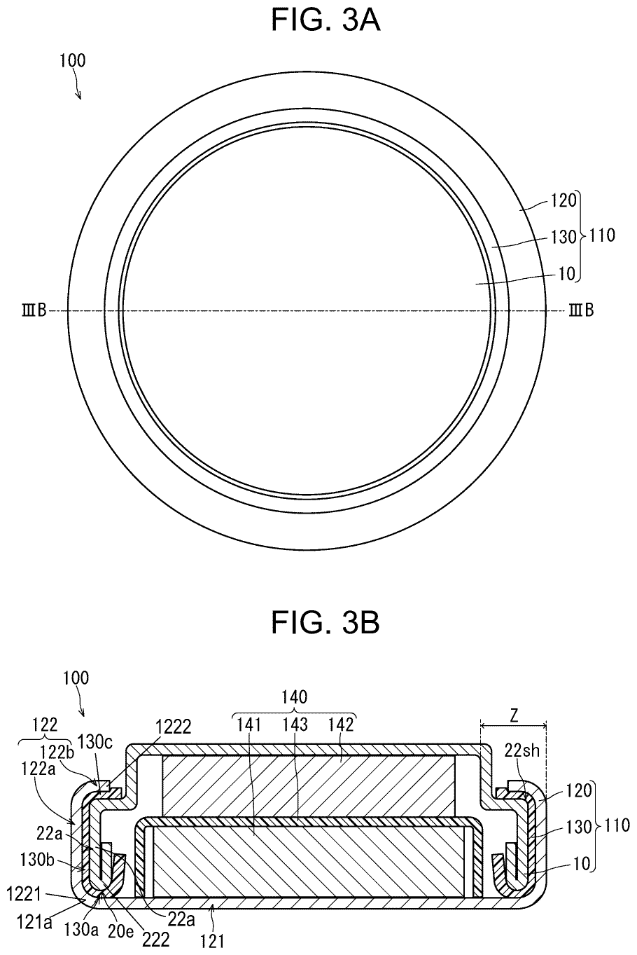

In a second exemplary embodiment, an example of flat battery (B) will be described. FIG. 3A illustrates a top view of flat battery 100 according to the second exemplary embodiment, and FIG. 3B illustrates a cross-sectional view taken along line IIIB-IIIB in FIG. 3A. Flat battery 100 includes exterior body 110 and battery elements 140 disposed in exterior body 110. Exterior body 110 includes case 120, gasket 130, and sealing plate 10. Sealing plate 10 is sealing plate (P), and may be sealing plate 10 described in the first exemplary embodiment. Case 120 functions as a positive electrode terminal, and sealing plate 10 functions as a negative electrode terminal.

Battery elements 140 include positive electrode 141 and negative electrode 142. In the second exemplary embodiment, an example of battery elements 140 including positive electrode 141, negative electrode 142, and separator 143 will be described. Each of positive electrode 141 and negative electrode 142 is a pellet electrode. Separator 143 is disposed between positive electrode 141 and negative electrode 142.

Case 120 includes a disk-shaped bottom 121 and side wall 122 (hereinafter, referred to as second side wall 122) extending from peripheral edge 121a of bottom 121. Side wall 122 has end 1221 connected to peripheral edge 121a of bottom 121 and end 1222 on an opposite side of end 1221. Side wall 122 includes a cylindrical shape surrounding central axis 20c and extending from end 1221 to end 1222. Side wall 122 includes cylindrical portion 122a and crimp 122b. Cylindrical portion 122a is a portion having a cylindrical shape and is disposed so as to surround first cylindrical portion 22a through gasket 130. Crimp 122b is bent to an inside of cylindrical shape of side wall 122 so as to cover at least a part (for example, shoulder 22sh) of step 22st through gasket 130. As a result, gasket 130 is fixed, and exterior body 110 is sealed.

Gasket 130 includes first portion 130a disposed between opening end 20e (i.e., fold 23) of formed body 20 and case 120, second portion 130b disposed between first cylindrical portion 22a and side wall 122 (more specifically, cylindrical portion 122a), and third portion 130c disposed between shoulder 22sh of step 22st and side wall 122.

Gasket 130 of flat battery 100 is compressed not only in first portion 130a and third portion 130c, but also in second portion 130b. In addition, second portion 130b is compressed by first cylindrical portion 22a and cylindrical portion 122a at substantially equal pressure. This is different from the configuration of FIG. 6 in which uniform compression is difficult due to presence of the step in the portion. In flat battery 100, therefore, sealability between sealing plate 10 and case 120 is high. In flat battery 100, it is possible to suppress leakage of an electrolytic solution in a high-temperature environment. Furthermore, in flat battery 100, high sealability can be maintained even when gasket 130 is thinned, so that gasket 130 can be thinned to increase capacity.

In flat battery 100, fold 23 is folded inward. It is therefore possible to prevent an edge of fold 23 from damaging gasket 130. Leakage of the electrolytic solution, therefore, can be particularly suppressed.

Furthermore, since the fold is folded back outward in the configuration illustrated in FIG. 6, sealing thickness Z (see FIG. 3B) increases. Here, sealing thickness Z is a distance between an innermost circumference of first cylindrical portion 22a of sealing plate 10 and an outermost circumference of cylindrical portion 122a of case 120. On the other hand, since fold 23 is folded inward in flat battery 100, sealing thickness Z can be reduced. In a plan view of formed body 20 viewed from opening end 20e, the entirety of fold 23 can be disposed outside disk 21. For example, a portion of fold 23 overlapping with first cylindrical portion 22a can be disposed at a position overlapping with step 22st in plan view. In flat battery 100, therefore, it is possible to increase volume of battery elements 140 that can be disposed per unit volume of exterior body 110. That is, in flat battery 100, it is possible to increase battery capacity (e.g., energy density) per unit volume.

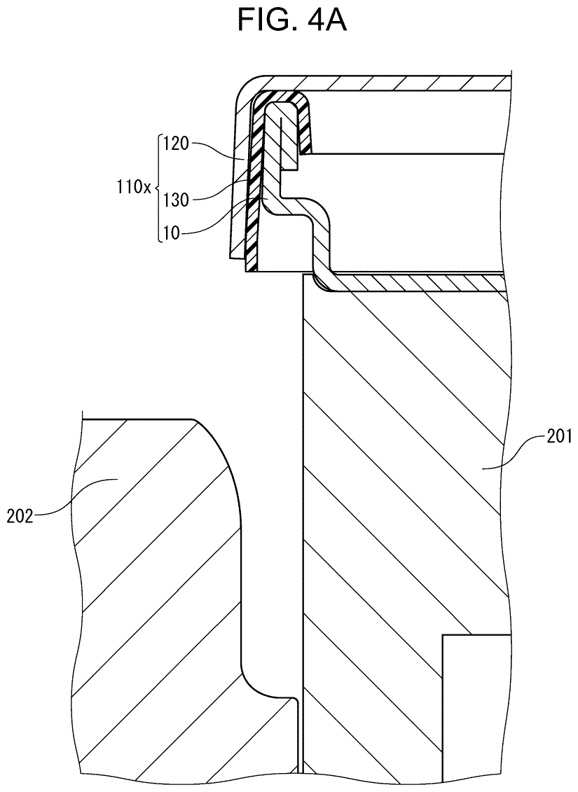

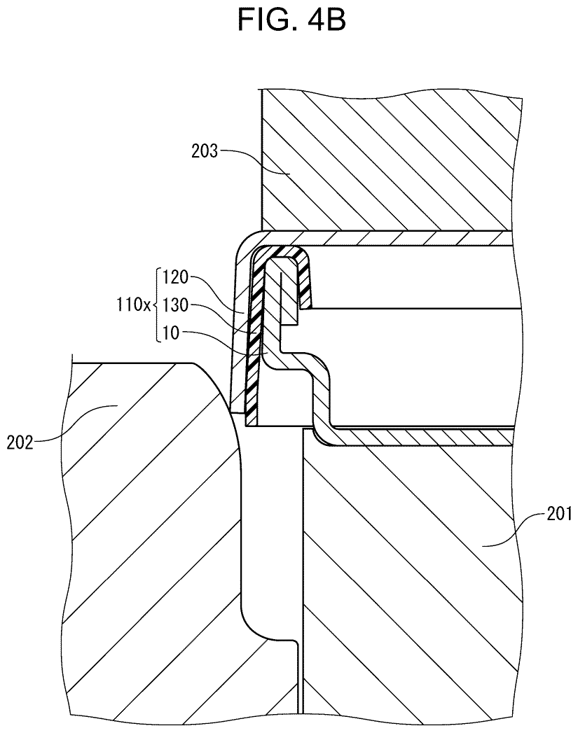

An example of a method for producing flat battery 100 will be described below. First, configuration elements of flat battery 100 are prepared. Battery elements 140 are then disposed in exterior body 110x before a crimping step (i.e., an example of assembling step) is performed. Exterior body 110x in which battery elements have been disposed is set on first die 201. FIG. 4A illustrates an example of a state at this time. Note that, for ease of understanding, illustration of the battery elements is omitted in FIGS. 4A to 4C. Next, as illustrated in FIGS. 4B and 4C, the crimping step is performed using first die 201, second die 202, and third die 203.

As illustrated in FIG. 4B, a diameter of a space inside second die 202 is set such that second portion 130b of gasket 130 is compressed through the crimping step. FIG. 4C illustrates a final stage of the crimping step. In the state of FIG. 4C, gasket 130 is compressed in a wide area. Thus, flat battery 100 can be produced.

### APPENDIX

The above description discloses following techniques.

### (Technique 1)

A sealing plate for a flat battery, the sealing plate including
a formed body of a metal plate, in which
the formed body includes a disk, a side wall extending from a peripheral edge of the disk, and a fold,
the side wall includes a step, and
in the fold, the metal plate is folded back to an inside of the side wall at an end of the side wall.

### (Technique 2)

The sealing plate according to Technique 1, in which the side wall includes a cylindrical portion existing between a base of the fold and the step.

### (Technique 3)

The sealing plate according to Technique 1 or 2, in which length L1 from the base of the fold to the tip of the fold in a direction parallel to a central axis of the formed body and length L2 from an inner surface of the step to the base of the fold in the direction parallel to the central axis satisfy 0.2<L1/L2<0.8.

### (Technique 4)

A flat battery including:
an exterior body; and
a positive electrode and a negative electrode disposed inside the exterior body, in which
the exterior body includes a case, a sealing plate, and a gasket at least a part of which is disposed between the case and the sealing plate,
the sealing plate includes a formed body of a metal plate,
the formed body includes a disk, a first side wall extending from a peripheral edge of the disk, and a fold,
the first side wall includes a step,
in the fold, the metal plate is folded back to an inside of the first side wall at an end of the first side wall,
the case includes a bottom having a disk shape and a second side wall extending from a peripheral edge of the bottom, and
a part of the second side wall is bent to an inside of the cylindrical shape of the second side wall and covers at least a part of the step through the gasket.

### (Technique 5)

The flat battery according to Technique 4, in which the first side wall includes a cylindrical portion existing between a base of the fold and the step.

### (Technique 6)

The flat battery according to Technique 5, in which
the gasket includes a first portion disposed between an opening end of the formed body and the bottom of the case, a second portion disposed between the cylindrical portion and the second side wall, and a third portion disposed between a shoulder of the step and the second side wall, and
ratio T/Tave of thickness T of the second portion at any position to average thickness Tave of the second portion is in a range of 0.8 to 1.2.

### (Technique 7)

The flat battery according to Technique 5 or 6, in which
the gasket includes a first portion disposed between an opening end of the formed body and the bottom of the case, a second portion disposed between the cylindrical portion and the second side wall, and a third portion disposed between a shoulder of the step and the second side wall,
a compression ratio of the gasket in the first portion is in a range of 30% to 70%,
a compression ratio of the gasket in the second portion is in a range of 20% to 50%, and
a compression ratio of the gasket in the third portion is in a range of 30% to 70%.

### (Technique 8)

The flat battery according to any one of Techniques 4 to 7, in which length L1 from the base of the fold to the tip of the fold in a direction parallel to a central axis of the formed body and length L2 from an inner surface of the step to the base of the fold in the direction parallel to the central axis satisfy 0.2<L1/L2<0.8.

### EXAMPLES

The present disclosure will be described in more detail with reference to examples.

### Experimental Example 1

In Experimental Example 1, a plurality of flat batteries (more specifically, lithium primary batteries) having sealing plates of different shapes were prepared and evaluated. Note that, in any of the flat batteries, diameter was 20 mm, and height was 3.2 mm.

### (Production of Battery A1)

Battery A1 having the same structure as flat battery 100 illustrated in FIGS. 3A and 3B was produced. That is, battery A1 was produced using a sealing plate having the same shape as sealing plate 10 illustrated in FIGS. 3A and 3B.

Thickness of a gasket before compression (before battery assembly) (i.e., thickness of a portion in contact with a case) was 0.15 mm. The sealing plate was formed of stainless steel (thickness: 0.25 mm). The case was formed of stainless steel (thickness: 0.25 mm).

### (Production of Battery A2)

Battery A2 was produced under the same conditions as for battery A1 except that thickness of a gasket before compression (i.e., thickness of a portion in contact with a case) was 0.30 mm and diameter of a sealing plate was reduced accordingly.

### (Production of Battery C1)

Battery C1 having the same structure as the flat battery illustrated in FIG. 5 was produced. As materials of a positive electrode, a negative electrode, a separator, an electrolytic solution, a sealing plate, a case, and a gasket, the same materials as those for battery A1 were used. Thickness of the gasket between a case side wall and a sealing plate side wall before compression was 0.30 mm.

### (Production of Battery C2)

Battery C2 having the same structure as the flat battery illustrated in FIG. 6 was produced. As materials of a positive electrode, a negative electrode, a separator, an electrolytic solution, a sealing plate, a case, and a gasket, the same materials as those for battery A1 were used. Thickness of the gasket between a case side wall and a sealing plate side wall before compression was 0.30 mm.

### (Compression Ratio of Gasket)

A compression ratio in the battery was measured for each of the gaskets of batteries A1, A2, C1, and C2. The compression ratio was measured at four points, namely a portion (i.e., a shoulder) adjacent to a shoulder of a step of the sealing plate, a portion (i.e., a cylindrical portion) adjacent to a cylindrical portion of the sealing plate, a portion (i.e., a bottom) adjacent to an opening end of the sealing plate, and a portion (i.e., edge) adjacent to an edge of the sealing plate. As described above, the compression ratio was determined by cutting the battery and measuring thickness of a cross section of the gasket.

### (High Temperature Storage Test)

10 units of each of batteries A1, A2, C1, and C2 were prepared. These batteries were then left under an environment of a relative humidity of 90% RH and 60° C., and presence or absence of leakage of the electrolytic solution was examined at regular intervals of days. Furthermore, the same test was also conducted in an environment of a relative humidity of 90% RH and 85° C.

Table 1 shows the number of batteries in which the leakage was present during the test. Table 1 also shows the compression ratio of the gasket in each battery. Battery A1 and battery A2 were flat batteries (B) according to the present embodiment using sealing plate (P).

TABLE 1

| Battery | | A1 | A2 | C1 | C2 |
|---|---|---|---|---|---|
| Fold | | Inside | Inside | None | Outside |
| Gasket thickness before | | 0.15 | 0.30 | 0.30 | 0.30 |
| compression (mm) | | | | | |
| Gasket | Shoulder | 50 | 50 | 50 | 50 |
| compression | Cylindrical | 35 | 35 | 0 | 0 |
| ratio (%) | portion | | | | |
| | Bottom | 50 | 50 | 50 | 50 |
| | Edge | 0 | 0 | 0 | 50 |

| Main compression portion | Bottom to | Two | Three |
|---|---|---|---|
| | shoulder area | locations | locations |

As shown in Table 1, in battery A1 and battery A2, the gasket was compressed in a wide area from the bottom to the shoulder including the cylindrical portion. On the other hand, in battery C1, the gasket was compressed mainly at two locations of the shoulder and the bottom, and in battery C2, the gasket was compressed mainly at three locations of the shoulder, the bottom, and the edge. A reason why the cylindrical portion was not compressed in battery C1 was that, as described above, since strength of the cylindrical portion of the sealing plate was weak in battery C1, it was difficult to compress the gasket at a portion adjacent to the cylindrical portion. A reason why the cylindrical portion was not compressed in battery C2 was that, in battery C2, in case where the gasket in the cylindrical portion of the sealing plate were compressed, the edge of the sealing plate would be likely to damage the gasket.

Table 2 shows results of the high temperature storage test of the gasket in each battery. The number of leakage in Table 2 is the number of batteries in which the leakage of the electrolytic solution was present among the 10 batteries.

TABLE 2

| Test conditions | | | | | |
|---|---|---|---|---|---|
| Temperature/ | | Number of batteries leaked | | | |
| relative humidity | Days passed | A1 | A2 | C1 | C2 |
| 60° C./90% RH | 50 | 0 | 0 | 0 | 0 |
| | 100 | 0 | 0 | 0 | 0 |
| | 150 | 0 | 0 | 1 | 0 |
| | 200 | 0 | 0 | 2 | 0 |
| | 250 | 0 | 0 | 4 | 2 |
| | 300 | 0 | 0 | 7 | 4 |
| 85° C./90% RH | 50 | 0 | 0 | 0 | 0 |
| | 100 | 0 | 0 | 1 | 0 |
| | 150 | 0 | 0 | 3 | 1 |
| | 200 | 0 | 0 | 7 | 3 |

As shown in Table 2, in batteries A1 and A2 according to the present embodiment, no leakage of the electrolytic solution was present. On the other hand, in batteries C1 and C2, the number of batteries in which the electrolytic solution was present increased with the lapse of time. As shown in Table 2, in batteries A1 and A2 according to the present embodiment, leakage of the electrolytic solution did not occur even at a time of high temperature storage, and high reliability was exhibited.

### Experimental Example 2

In Experimental Example 2, battery capacity (e.g., discharge capacity) when the thickness of the gasket before the compression (before battery assembly) was changed was obtained through calculation for each of batteries A1, C1, and C2 prepared in the Experimental Example 1. Note that diameter of the sealing plate was changed in accordance with the thickness of the gasket Conditions other than the thickness of the gasket and the diameter of the sealing plate were the same as in the Experimental Example 1.

In the Experimental Example 2, first, sealing thickness Z (see FIG. 3B) when a gasket having a predetermined thickness was used was determined. The battery capacity was then obtained through calculation on the basis of sealing thickness Z. Since the diameter and the height of the battery are the diameter and the height described in the Experimental Example 1, the volume of the battery elements that can be disposed in the exterior body also changes when sealing thickness Z changes. Battery capacity of the battery in the Experimental Example 2 was calculated using the volume of the battery elements that can be disposed in the exterior body and measurement values of volume and battery capacity of battery elements of a reference battery.

FIG. 7 illustrates a result of the calculation of the battery capacity. In FIG. 7, “gasket thickness” before the battery assembly is thickness at a portion (e.g., cylindrical portion) adjacent to the cylindrical portion (e.g., first cylindrical portion 22a) of the sealing plate. In FIG. 7, “compression ratio” and “thickness” after the battery assembly are the compression ratio and the thickness in the cylindrical portion of the gasket. “Thickness Z” after the battery assembly is sealing thickness Z.

As illustrated in FIG. 7, the battery capacity of battery A1 was the highest under a condition that the thickness of the gasket before the battery assembly was the same. As shown in the Experimental Example 1, in the case of battery A1, leakage of the electrolytic solution can be suppressed even when the thickness of the gasket before the battery assembly is 0.15 mm or less. It is therefore possible to further increase the battery capacity. In the case of batteries C1 and C2, on the other hand, even if the thickness of the gasket before the battery assembly was 0.30 mm, suppression of the leakage of the electrolytic solution was insufficient. When battery A1 is compared with batteries C1 and C2, therefore, the capacity of battery A1 can be significantly increased. When an effect of suppressing the leakage of the electrolytic solution is made equivalent to that of a conventional battery, battery A1 can have a significantly higher capacity.

### INDUSTRIAL APPLICABILITY

The present disclosure can be used for a sealing plate and a flat battery.

### REFERENCE MARKS IN THE DRAWINGS

10 sealing plate
20 formed body
20c central axis
20e opening end
21 disk
22 side wall (which is referred to as first side wall)
22sh shoulder
22st step
23 fold
23a base of fold
100 flat battery
110 exterior body
120 case
121 bottom
122 side wall (which is referred to as second side wall)
122a cylindrical portion
122b crimp
130 gasket
141 positive electrode
142 negative electrode

1. A sealing plate for a flat battery, the sealing plate comprising
a formed body of a metal plate, wherein
the formed body includes:
a disk;
a side wall having a cylindrical shape extending from a first end connected to a peripheral edge of the disk to a second end; and
a fold folded back from a base of the side wall connected to the second end and extending to a tip,
the side wall includes a step, and
in the fold, the metal plate is folded back to an inside of the cylindrical shape of the side wall at the second end of the side wall.

2. The sealing plate according to claim 1, wherein
the side wall includes a cylindrical portion existing between the base of the fold and the step.

3. The sealing plate according to claim 1, wherein
length L1 from the base of the fold to the tip of the fold in a direction parallel to a central axis of the formed body and length L2 from an inner surface of the step to the base of the fold in the direction parallel to the central axis satisfy 0.2<L1/L2<0.8.

4. A flat battery comprising:
an exterior body; and
a positive electrode and a negative electrode disposed inside the exterior body, wherein
the exterior body includes a case, a sealing plate, and a gasket at least a part of which is disposed between the case and the sealing plate,
the sealing plate includes a formed body of a metal plate,
the formed body includes a disk, a first side wall having a cylindrical shape extending from a first end connected to a peripheral edge of the disk to a second end portion, and a fold folded back from a base of the side wall connected to the second end and extending to a tip,
the first side wall includes a step,
in the fold, the metal plate is folded back to an inside of the cylindrical shape of the first side wall at the second end of the first side wall,
the case includes a bottom having a disk shape and a second side wall having a cylindrical shape extending from a peripheral edge of the bottom, and
a part of the second side wall is bent to an inside of the cylindrical shape of the second side wall and covers at least a part of the step through the gasket.

5. The flat battery according to claim 4, wherein
the first side wall includes a cylindrical portion existing between the base of the fold and the step.

6. The flat battery according to claim 5, wherein
a part of the fold of the formed body constitutes an opening end of the formed body,
the gasket includes a first portion disposed between the opening end of the formed body and the bottom of the case, a second portion disposed between the cylindrical portion and the second side wall, and a third portion disposed between a shoulder of the step and the second side wall, and
a ratio T/Tave of thickness T of the second portion at any position to average thickness Tave of the second portion is in a range of 0.8 to 1.2.

7. The flat battery according to claim 5, wherein
the gasket includes a first portion disposed between the opening end of the formed body and the bottom of the case, a second portion disposed between the cylindrical portion and the second side wall, and a third portion disposed between a shoulder of the step and the second side wall,
a compression ratio of the gasket in the first portion is in a range of 30% to 70%,
a compression ratio of the gasket in the second portion is in a range of 20% to 50%, and
a compression ratio of the gasket in the third portion is in a range of 30% to 70%.

8. The flat battery according to claim 4, wherein
length L1 from the base of the fold to the tip of the fold in a direction parallel to a central axis of the formed body and length L2 from an inner surface of the step to the base of the fold in the direction parallel to the central axis satisfy 0.2<L1/L2<0.8.

9. A sealing plate configured to be used in a flat battery, the sealing plate comprising
a formed body of a metal plate, wherein
the formed body includes a disk, a first side wall having a cylindrical shape extending from a first end connected to a peripheral edge of the disk to a second end portion, and a fold folded back from a base of the side wall connected to the second end and extending to a tip,
the first side wall includes a step,
in the fold, the metal plate is folded back to an inside of the cylindrical shape of the first side wall at the second end of the first side wall,
the flat battery includes an exterior body and a positive electrode and a negative electrode disposed inside the exterior body,
the exterior body includes a case, the sealing plate, and a gasket at least a part of which is disposed between the case and the sealing plate,
the case includes a bottom having a disk shape and a second side wall having a cylindrical shape extending from a peripheral edge of the bottom, and
a part of the second side wall is bent to an inside of the cylindrical shape of the second side wall and covers at least a part of the step through the gasket.

10. The sealing plate according to claim 9, wherein
the side wall includes a cylindrical portion existing between the base of the fold and the step.

11. The sealing plate according to claim 9, wherein
length L1 from the base of the fold to the tip of the fold in a direction parallel to a central axis of the formed body and length L2 from an inner surface of the step to the base of the fold in the direction parallel to the central axis satisfy 0.2<L1/L2<0.8.
